(19) United States
(12) Patent Application Publication
(10) Pub. No.: US 2003/0187661 A1
(43) Pub. Date: Oct. 2, 2003

(54) Meaning processor

(76) Inventors: Peter Warren, Chattanooga, TN (US); Mindy Camphouse, Usk, WA (US)

Correspondence Address: Manuel R. Valcarcel, IV, GREENBERG TRAURIG, P.A., 1221 Brickell Avenue, Miami, FL, 33131, US

(21) Appl. No.: 10/339,064

(22) Filed: Jan. 9, 2003

Related U.S. Application Data
(60) Provisional application No. 60/347,380, filed on Jan. 10, 2002.

(51) Int. Cl. G10L 11/00

(52) U.S. Cl. 704/277

(57) ABSTRACT

A meaning processor software system and method for use in conjunction with an any-to-any component computing system for simulation of human-type information processing and enabling natural language communication with the computing system. The invention comprises a method and system for designating distinguishable symbols to individual meanings of individual words as well as to individual component meanings of individual words integrated with a data base comprising records of said symbols for said individual meanings configured into different programmable fields such that one or more software applications from said any-to-any component computing system can process said symbols to execute commands created from combinations of said symbols to produce results that simulate the expected responses that humans would have to commands given to humans using natural language terms.

### TECHNICAL FIELD

The present invention relates generally to the field of computer software applications. In particular, it relates to software applications that enable computers to process meanings of words in a human-like manner.

### BACKGROUND OF THE INVENTION

Humans communicate in large part by use of words. The ability of computers to use words in a similar fashion to the manner in which a human does, and to produce the same results upon hearing them or receiving them as a human would, would be an important addition to the ease with which computers could be used.

The subject of human-like use of words by a computer divides into two principal areas that are analogous to the manner in which a human treats words:

1. The ability to understand exactly what the words mean.

2. The ability to use the understood meaning to perform the corresponding expected activity.

For example, a secretary may understand perfectly well (as in 1 above) what her boss means when he says “Jill, please do the balance sheet for General Motors for the last year.”

However, she may be completely incapable of performing the action required by that meaning (as in 2 above)—she may be incapable of actually doing the balance sheet.

Hence, the ability to understand the meaning of words is one of two key elements that are required in order to produce human-like activity as a result of a computer's reception of words that would produce a particular activity in a human hearing those same words. This ability is termed herein “Meaning Processing.”

This invention deals with enabling a computer to have the ability to understand the meaning of the words it receives, i.e., to do meaning processing, the activity described above. The ability to perform the required resulting action is necessarily an intimately integrated enablement, and is described in detail in U.S. Non-Provisional Patent Application Serial No. 09/712,581 titled “Any to Any Component Computing System,” filed also as PCT Application No. PCT/US00/31231 which was published on May 17, 2001, the Specification and drawings of which are incorporated herein by reference.

Prior art computing software has mainly processed words on the basis of keywords, a term that means in practice, the use of particular spellings—a specific series of characters—that the user or the programmers considers to be of greatest importance to the matter at hand. Hence, searching a letter for a word that is spelled “bananas” is considered to be using a keyword to search that letter, as opposed to a word that is spelled “the” which is not in that instance considered to be a “keyword.”

The disadvantages of this methodology are several:

1. A particular spelling may have several completely different meanings, for example:

a. “fax” can be the piece of paper faxed.

b. “fax” can mean “the fax machine.”

c. “fax” can mean the action that is required—“please fax this to Joe.”

In this example, the disadvantage is that, while a human may actually be referring to only one of those meanings—each of which are dramatically different from one another and require potentially completely different actions to be performed—keyword technology provides no methodology to distinguish between those different meanings, all of which are identical to one another in a keyword framework.

Consequently, when keyword methodology is in use, a user is unable to specify a search using one of those particular meanings, since there is no way to distinguish them to the computer. Consequently, the computer returns items that match all the meanings of that word, even though the human only requires items that match one of that word's meanings.

2. A further disadvantage of keyword technology is that some meanings of some particular spelling (words) are the same as some meanings of other spellings (other words). For example:

a. One meaning of the word “terminate”—but only one of its several meanings—means that the person will no longer have a job.

b. One meaning of the word “fire” is also that a person will no longer have a job.

However the word “terminate” has other meanings than “the person will no longer have a job.” It can, for example, mean “that person is to be killed,” and this example serves to illustrate that it is necessary for a highly mechanically-enabled computer to distinguish between the two meanings clearly and reliably.

The word “fire” also has other meanings, as in “shoot a gun” or “the heat source on the hearth.” Again it is undesirable for a computer to be unable to distinguish the different meanings.

Hence one meaning of each of the two keywords “terminate” and “fire” is identical, while other meanings are different, and it is important to fully enable a computer not to confuse the different meanings.

However, in keyword methodology, no methodology exists with which to distinguish between the different meanings of a given keyword, and consequently, Keyword technology is reasonably effective only in an extremely limited environment, where the number of possible meanings if a given set of characters is severely reduced, such as in ordering a telephone to dial a named person.

As the breadth of the environment in which the keyword technology is used becomes broader, eventually encompassing environments such as Internet search engines where the entirety of many languages is in play, the number of potential meanings of identical spellings increases enormously as does the potential interplay between them.

In an effort to overcome these shortcomings, much effort has been placed into what are termed “knowledge based systems” which come in many varieties.

One such system depends on different uses of probability theory in which it is calculated that it is most probable that a particular meaning of a word that is in use is—for example—“the person no longer has a job” and this is based essentially on the observation that in the environment in which the word occurs, such and such a meaning is the most common and hence the most likely.

In essence, while this appears superficially to be a meaning-based activity, it is not, as the actual process is the direct assignation of particular software task to a particular keyword by probability software, and the meaning of the characters that are the word are not in fact dealt with at all.

The primary disadvantage of probability-based systems is that the improbable frequently occurs and when it does, in order to be considered reliable enough to use, a computer had better handle it correctly and probability theory does not include mechanisms to handle the improbable.

For example, if a person is attached by a person who is a crook, and shouts at a mechanically enabled computer “terminate that crook” and the computer says to the crook “you are removed from your job, please report to the personnel department” it is unlikely that the computer will be in use for any length of time.

Efforts to address these problems in the prior art has been to the use of a brute force method, namely to build, over many years, enormous database of “knowledge” in which sophisticated words and rules are used to ascribe meanings in some manner.

While such brute force systems have proven themselves successful as a sort of question and answer machine, in which a human can pose a question and mostly get the right answer, their disadvantage is the degree to which the human gets the wrong answer at the same time as the right one is still considerable—as the result of any internet search shows, even when using the most sophisticated search engines. While the right answer usually is returned, it is obscured and cluttered by a considerable number of answers that are not in actual fact the right answer.

The second disadvantage of such brute force knowledge base question and answer machines is that until now, no one has discovered any widely usable methodology that enables the computer to proceed to step (2) named in the introduction, namely to enable the answer produced by the question or order to enable the ability to use the understood meaning to perform the corresponding activity.

It is an observable fact that humans perform actions based on meanings, not on spellings. For example, a Personnel Manager, told to “terminate the receptionist” or told to “fire the receptionist” will perform the absolutely identical activities as a result of those words. Hence, the one of the fundamental disadvantages and fundamental problems of the prior art methods of word handling is that they are all based, in some manner or another, on character recognition—recognizing that one set of characters is the same as another. In fact, there has been no system for ascribing in a computer particular meanings to individual meanings of a particular spelling in such a manner that they are individually addressable.

In summary, the disadvantages of prior technology for the use of words by software, are firstly that the methodologies are insufficiently precise and secondly, the output from software dealing with words in the prior art manner has not enabled software to be constructed that can then execute and reliably produce the result the human expects from a given word input.

### SUMMARY OF THE INVENTION

The present invention is based around detecting the methods that humans themselves use to detect the correct meanings in use, and then implementing emulations of these methods in a software environment.

Firstly, the invention consists of a method for designating unambiguous symbols—numbers—to the individual meanings of individual words, as well as for designating unambiguous symbols—numbers—to component meanings that are in fact contained in a particular word. This methodology is termed “Number Concept Language” or “NCL” in addition to enabling individual meanings and parts of meanings of word to be designated unambiguously, NCL is the enabling methodology that enables software to be set up so that languages to be translated automatically and accurately between one another.

This is because, while one word frequently does not have an exactly equivalent word in another language, the component meanings of a word always do have exact equivalents.

For example, the words “I worked” exists in the English language, and is translated into NCL by translating its component meanings into NCL. This the word “worked” might be translated into NCL as

| | | |
|---|---|---|
| Translation part 1 | I | = 144 |
| Translation part 2 | work- | = 439 |
| Translation part 3 | -ed = past time | = 247 |

Now in another language, a set of characters might exist—illustrated for this example, where

| | |
|---|---|
| XYXY means | I work |
| ZZZZ means | past time |

In this fictional language, if someone said XYXY ZZZZ this would mean “I worked”

When XYXY ZZZZ is translated into NCL the result is that it is represented by NCL identically, even though the 2 languages from which the NCL has been translated have no direct equivalents:

| | | |
|---|---|---|
| Translation part 1 | of XYXY | = 439 |
| Translation part 2 | of XYXY | = 144 |
| Translation part 3 | of ZZZZ | = 247 |

Once a spoken language has been translated into NCL (which must be done mainly by hand though some of it can be automated) and a second and further spoken language has been translated similarly into NCL, it becomes possible to create software that looks up the translation of entered text automatically and records its NCL translation.

It is then further possible for different but similar software to read the NCL recording and, by looking up the spoken word equivalent in whatever spoken language the user chooses, to output the chosen NCL in any language for which a translation exists.

State of the art automatic lookup and translation—for example between computer languages, is extremely current; for example, all higher-level computer languages automatically translate into machine code that a CPU can actually execute. Hence, it is quite within the capability of anyone reasonably competent in the appropriate disciplines of the state of the art to write software to enable automatic translation into and out of NCL, and to write software that will simultaneously translate NCL into any number of spoken languages for which an NCL translation exists. It is further within state of the art skills to arrange for software to do this with virtually no delay, hence enabling accurate handheld simultaneous translators to be built.

The output and recording of NCL output from the software translating into NCL can be in any form that is convenient to the method in use, provided that all that is required is translation of spoken language (which obviously can be printed or exist in any machine-readable form).

While the methodology of NCL described above is useful by itself as a spoken language translation technology, it can facilitate, but is wholly inadequate by itself to enable the spoken word (translated into NCL) to be used to cause “the understood meaning to perform the corresponding expected activity” as described in the summary point 2. It is inadequate to do this because a simple free-form NCL output does not enable any standard and automatic relationship to be established between the NCL output and the software that it should cause to execute, thereby producing “the corresponding expected activity.” In order to establish a correspondence between NCL output and the software that it should cause to execute, a further invention is required, termed the “Data Relation Table” or “DRT.”

The DRT essentially divides the meanings of words (expressed in NCL) representing the physical universe and other words representing those things that only life can create and which only exist in the imagination (such as names “John”, “IMB”, qualities like “good”, “bad”, “blue”, “fast”, numbers, etc.) and putting these into a standardized database record form, termed “a DRT record.”

Through various mechanisms described in the associated application “Any To Any Component Computing System” incorporated herein by reference, DRT records can be made to record in a standardized fashion, either NCL (in a more sophisticated implementation) or words themselves (in a less sophisticated but still very useful implementation). When words are used instead of true NCL, they are still used in a manner that mimics NCL, but of course, the ability to translate between languages does not then exist.

DRT records have many advantages, but one of them is that they act as standard interface between any language, and software.

Meaning Processing is the subject of taking language and turning it into a DRT record, and doing this then enables software to be related to it, using the field parallel and record parallel principles. This in turn enables the computer to:

1. “Understand” exactly what the words mean—i.e., detect the particular meaning in use; and then to

2. Relate the understood meaning to software in order to perform the corresponding activity the human expects to occur based on those words.

Once these basic principles are understood, it is immediately apparent that there are several ways of performing Meaning Processing, and these break down into three main categories and the presence of the underlying DRT records enables any mixture of these different Meaning Processing methods to be used simultaneously and interactively.

Novel Features and Advantages

The novel features of the invention described herein include the following:

Grammar is ignored as a means of detecting meanings.

Language as a whole is treated as a compressed transmission medium in which compressions, meaning-designating protocols and the data itself are intermixed.

Individual meanings of words are manually detected by review of their use in texts. In effect, dictionary defined meanings of words are not very useful to this process because a) they are usually related to grammar, which is an un-useful methodology in this context and b) such definitions of the meanings of words are not fine-grained enough to be useful. Too many meanings that do have a difference between them are defined as one single meaning and this prevents accurate Meaning Processing.

Individual meanings of words are individually recorded in such a manner that the recording contains, or refers to the requirement rules, conditions, and logics needed to process that meaning. Additionally, these things are recorded either in relation to the word itself or in relation to the NCL translation of the word.

Individual meanings of individual words are processed individually by individual code that—preferably—processes only that meaning and by other also independent software that processes the results of the previous level processing.

Output can be, but does not have to be formatted into a DRT record, but, if so formatted, this makes it easier to relate the commands represented by the Meaning Processing DRT record output to data and software that has been previously recorded in DRT format. Formatting meaning Processing output in DRT record format facilitates relating the commands and data entered by the user to software and data that are necessary to produce the execution that time user anticipates should occur based on the input he gave.

The NCL described in the invention ascribes unambiguous symbols to component meanings that make up the entire meaning of a word, and it is these component meaning parts that are then individually processed.

The DRT described in the invention provides a formalized universal interface between meanings, user data and software in such a manner that is capable, with various mechanisms, of recording. any data whatsoever without requiring any. adaptation of the structure in order to do so.

The advantages of the invention described here include:

It enables spoken language to be used as a control input for a computer.

It overcomes the problems explained in the background that are intrinsic in the use of keywords.

It enables data to be very precisely selected based on spoken language written input. (Voice recognition is immaterial to this invention and may be used as an input to it. By “spoken language” is meant the language that is in current use in the population, whether spoken or written).

It enables spoken language input to a computer in such a fashion that this input can be related to software and pre-existing data and by so doing, results in the computer performing the execution the user would expect another human to produce based on the same input to that other human.

It enables a computer to deal with the complexity of any and many languages and to do so simultaneously for all purposes.

It enables a computer to deal with mixed language input—input that occurs in words taken from different languages.

It enables a computer to add new words and meanings on the fly and process them without requiring programmer intervention to do so.

It enables any mixture of input and output methods to be used simultaneously—visual (screen) and written or spoken language(s).

Essentially and in summary, it enables a computer to emulate a human in its behavior in response to commands given to it.

### BRIEF DESCRIPTION OF THE DRAWINGS

FIG. 1 depicts the basic elements of a preferred embodiment of the Meaning processor system.

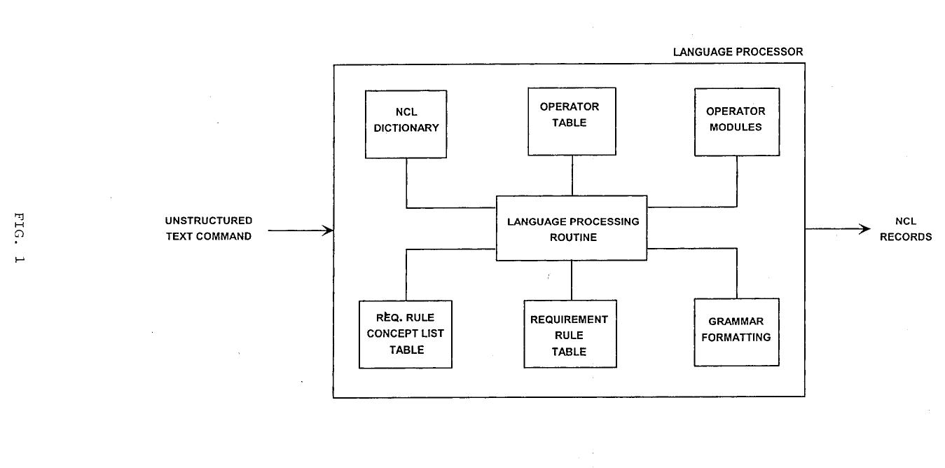

FIG. 2 is a flow chart showing the main steps of a preferred embodiment of the meaning processor process.

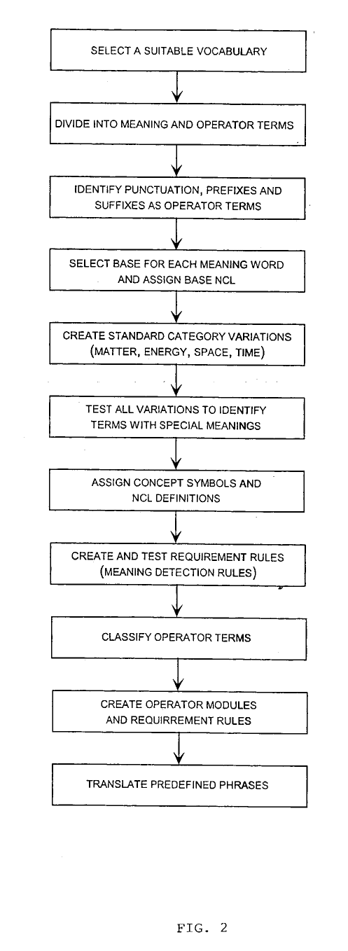

FIG. 3 depicts a sample of the number concept language methodology and data storage dictionary in a preferred embodiment.

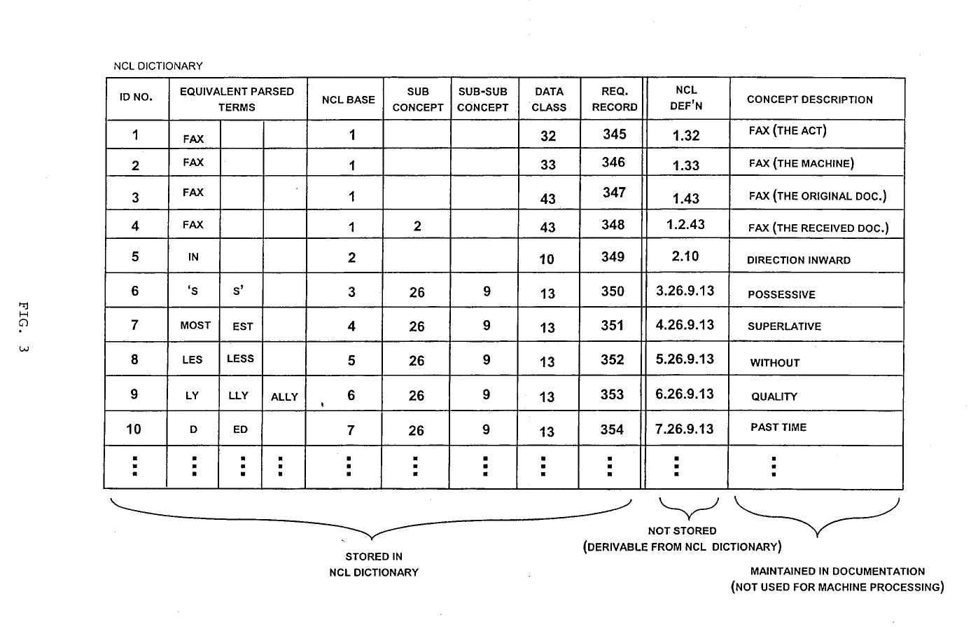

FIG. 4 depicts a sample requirement record concept list table and requirement rule table.

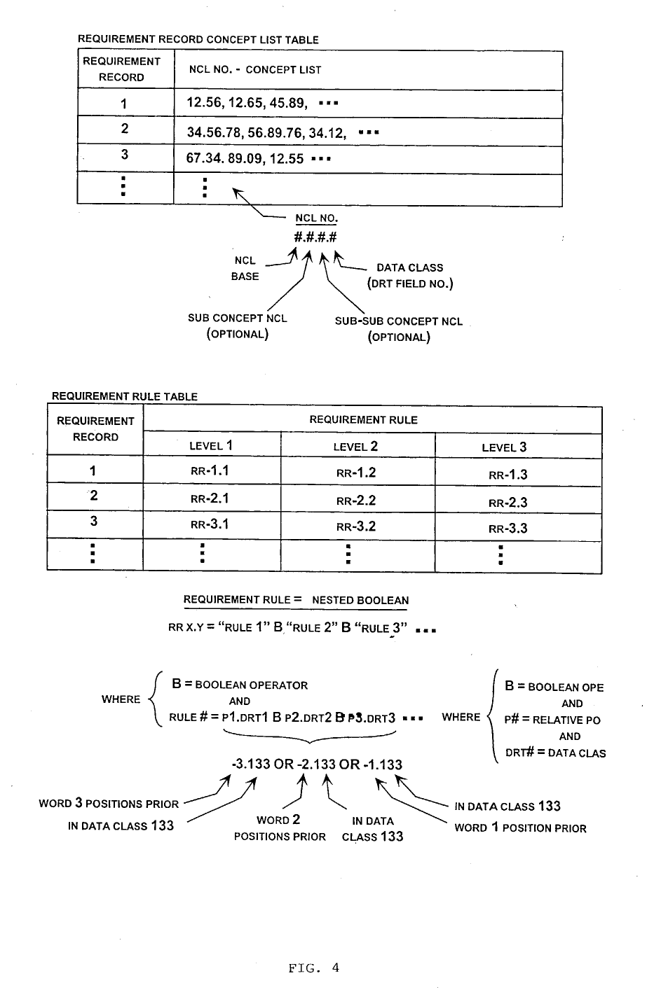

FIG. 5 depicts a sample operator table.

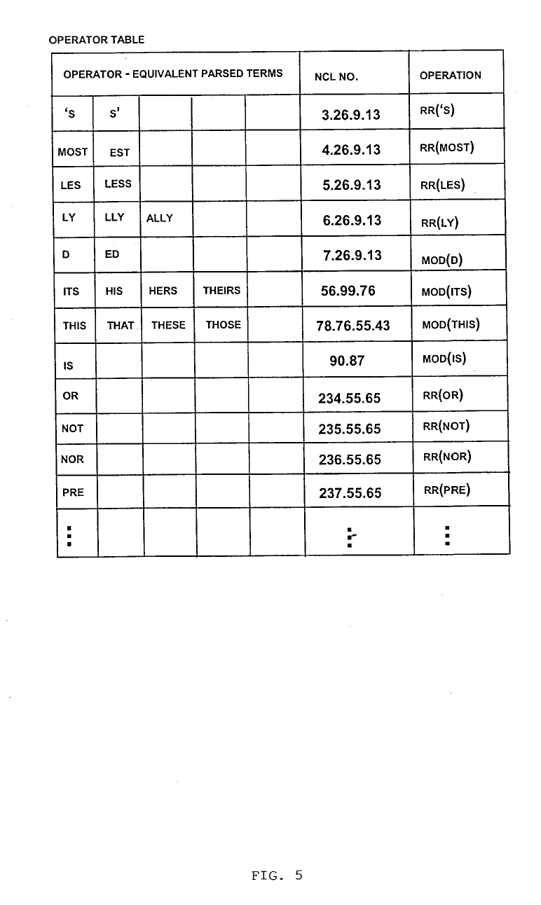

FIG. 6 describes the overall process flow of the present invention in a preferred embodiment.

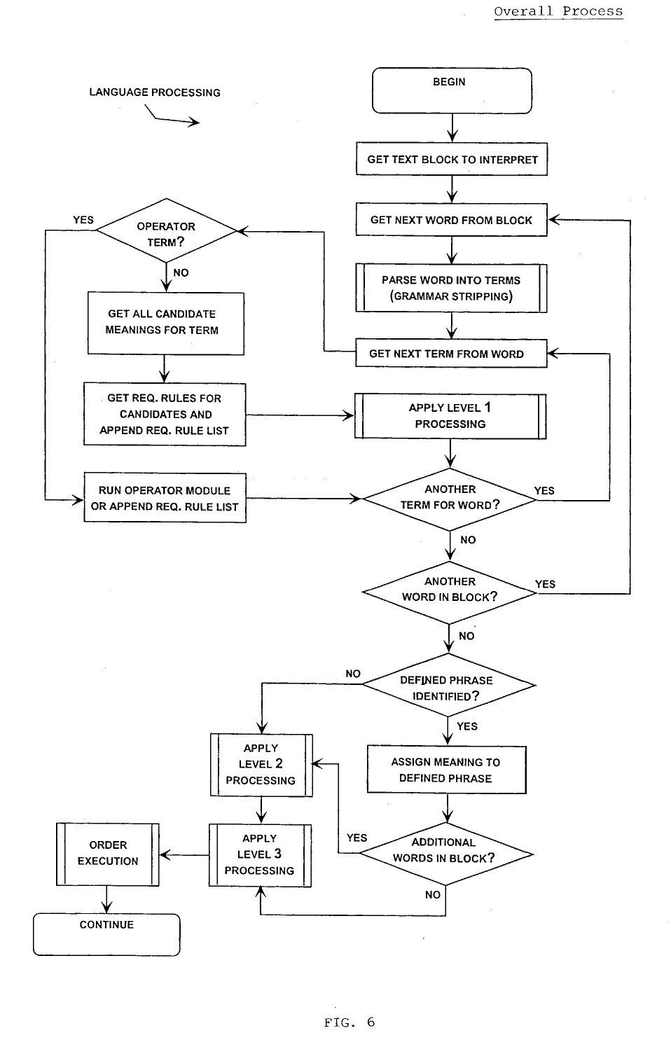

FIG. 7 describes the grammar stripping process flow of the present invention in a preferred embodiment.

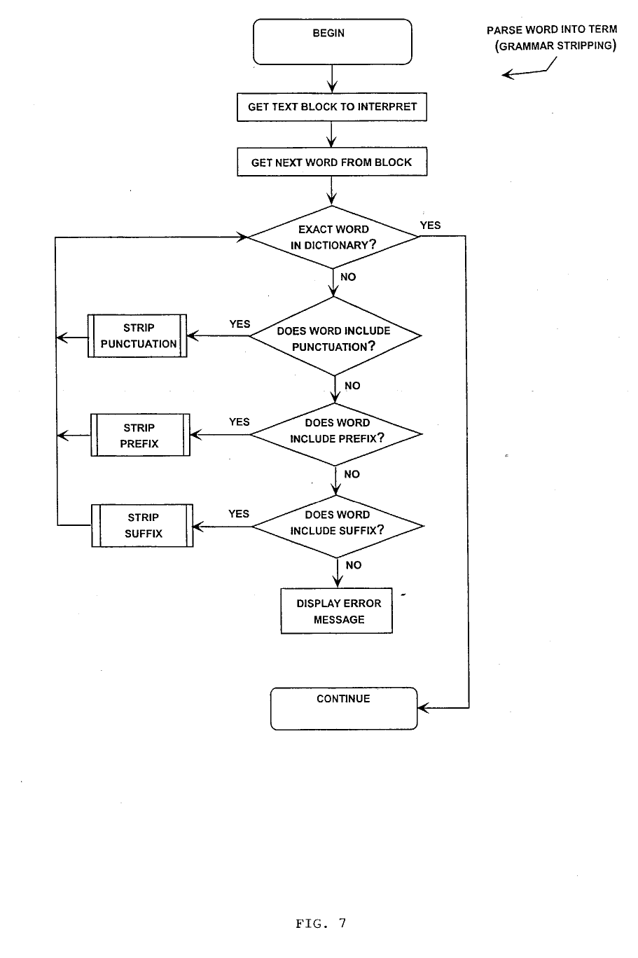

FIG. 8 describes the punctuation stripping process flow of the present invention in a preferred embodiment.

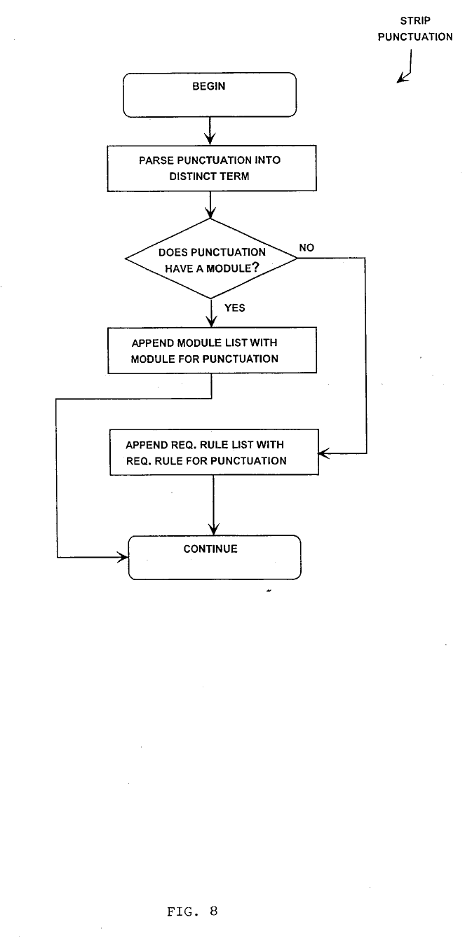

FIG. 9 describes the prefix stripping process flow of the present invention in a preferred embodiment.

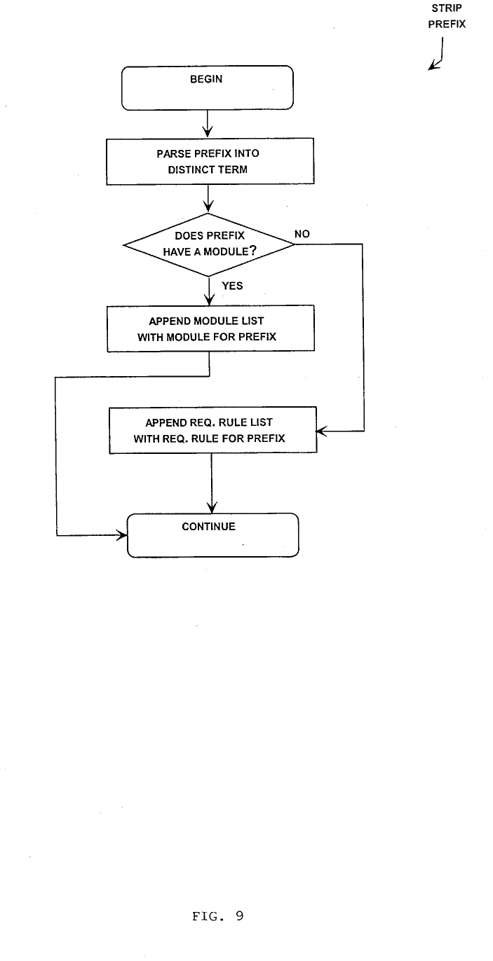

FIG. 10 describes the suffix stripping process flow of the present invention in a preferred embodiment.

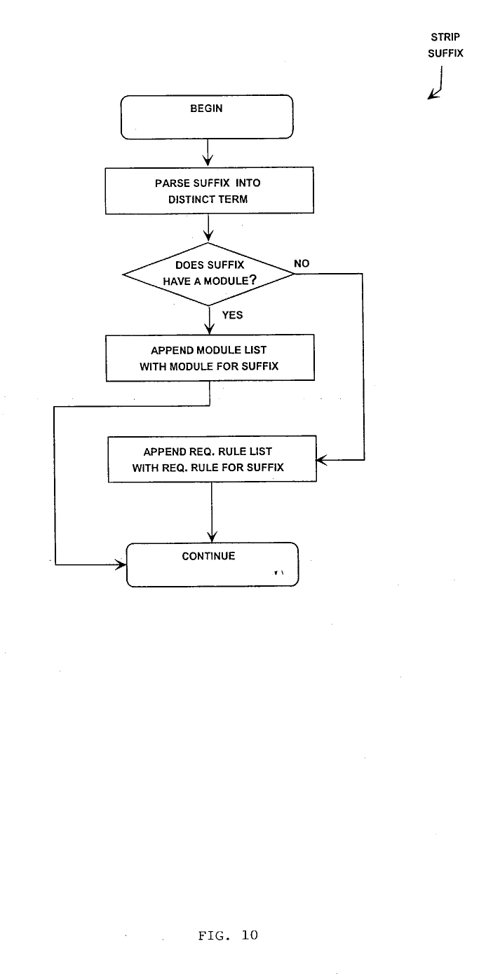

FIG. 11 depicts the Level I processing process flow of the present invention in a preferred embodiment.

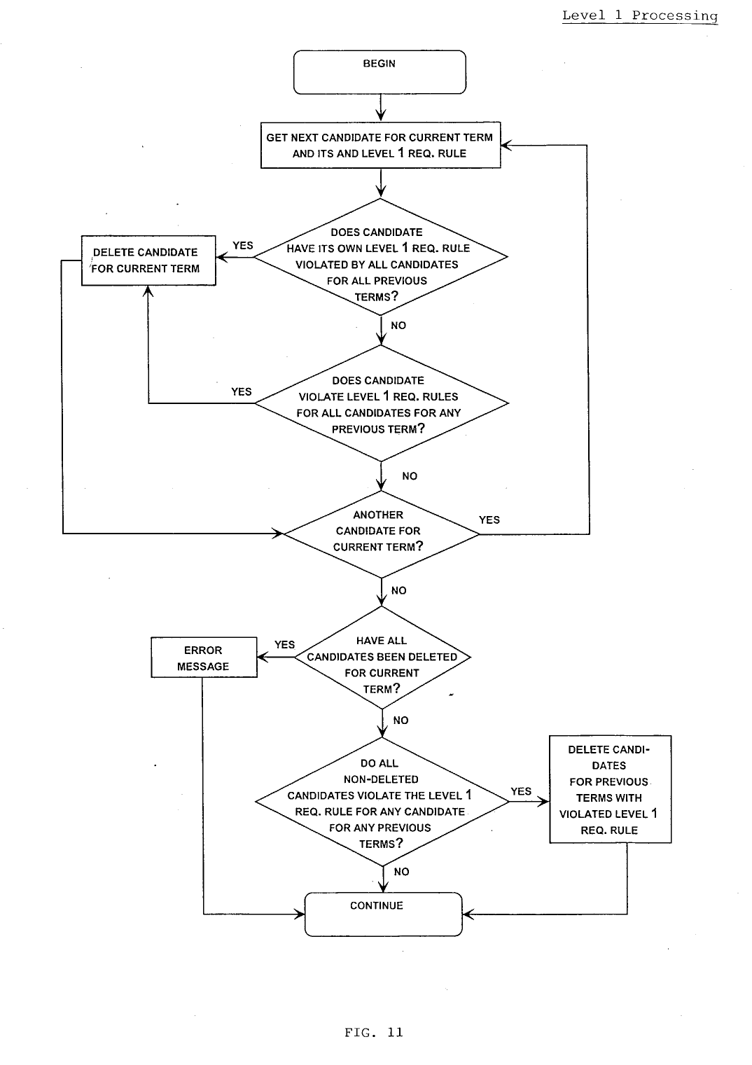

FIG. 12 depicts the Level II processing process flow of the present invention in a preferred embodiment.

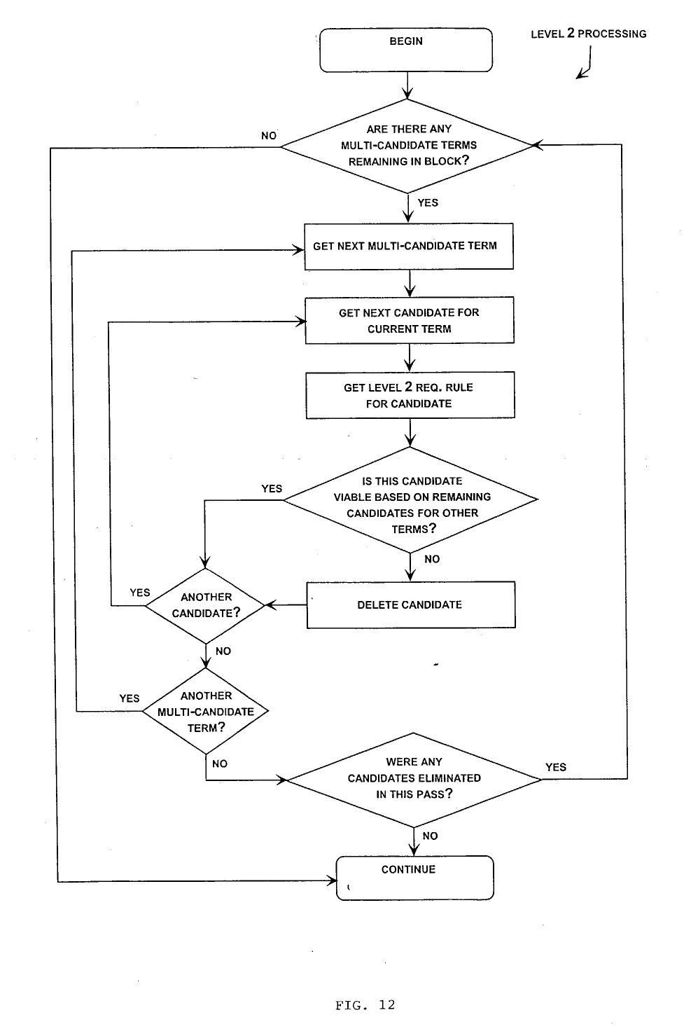

FIG. 13 depicts the Level III processing process flow of the present invention in a preferred embodiment.

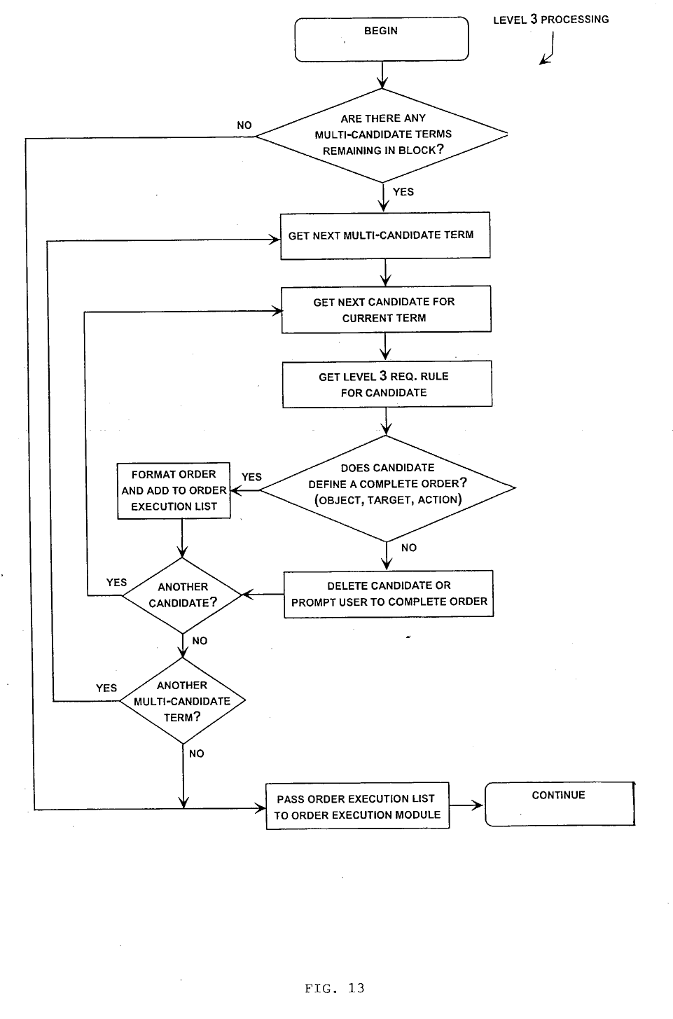

FIG. 14 depicts the order or command execution process flow of the present invention in a preferred embodiment.

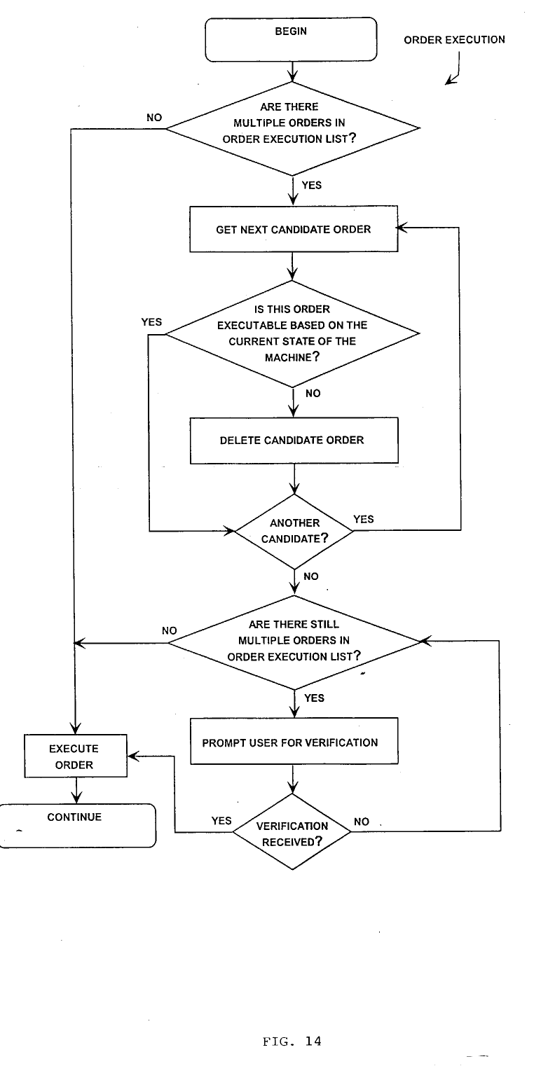

### DETAILED DESCRIPTION OF A PREFERRED EMBODIMENT

The present invention comprises a meaning processor software system and method for use in conjunction with an any-to-any component computing system for simulation of human-type information processing and enabling natural language communication with the computing system. The invention comprises a method and system for designating distinguishable symbols to individual meanings of individual words as well as to individual component meanings of individual words integrated with a data base comprising records of said symbols for said individual meanings configured into different programmable fields such that one or more software applications from said any-to-any component computing system can process said symbols to execute commands created from combinations of said symbols to produce results that simulate the expected responses that humans would have to commands given to humans using natural language terms. The system for computer-based natural language word meaning processing for use with a computer-based system for processing natural language word commands to produce actions or other results that would generally be produced by a human interpreting the particular natural language word command, comprises: means for assigning a distinguishable symbol corresponding to each individual meaning of each particular individual natural language words and to each individual meaning of each particular component of said natural language words, means for further categorizing said distinguishable symbols into programmable category field that include the applicable requirement rules, conditions and logics needed for another computer software system to interface with said database to translate word commands and process the meanings of such words correctly, and means for storing said categorized distinguishable symbols in a data relation record database that interfaces and is compatible with said system for processing commands to produce actions or other results, such that when a natural language word is inputted into a computer that utilizes said process, said natural language words are translated into said distinguishable symbols and said system for processing commands to produce desired actions or other results understands said translation and executes said translated command to produce the result that a human would generally intend and interpret has been requested by said command.

The method of the present invention is a method for computer-based natural language word meaning processing for use with a computer-based system for processing natural language word commands to produce actions or other results that would generally be produced by a human interpreting the particular natural language word command, comprising the following steps: designating a distinguishable symbol corresponding to each individual meaning of each particular individual natural language words and to each individual meaning of each particular component of said natural language words, further categorizing said distinguishable symbols into programmable category field that include the applicable requirement rules, conditions and logics needed for another computer software system to interface with said database to translate word commands and process the meanings of such words correctly, storing said categorized distinguishable symbols in a data relation record database that interfaces and is compatible with said system for processing commands to produce actions or other results, such that when a natural language word is inputted into a computer that utilizes said process, said natural language words are translated into said distinguishable symbols and said system for processing commands to produce desired actions or other results understands said translation and executes said translated command to produce the result that a human would generally intend and interpret has been requested by said command.

Screen Based Meaning Processing—Meaning Processing Level 0

In Level 0 Meaning Processing, underlying DRT records are mirrored to the screen, on a one field one visual area relationship, and the screen displays simultaneously suitable field parallel prompts, i.e., texts that tell the user what to enter, labels (i.e., texts that tell the user what that data is once it has been entered) and help —explanations related specifically to the type of meaning being entered or displayed in that field.

It is the wording of the prompt or label that acts to bring Meaning Processing about. It is of course very common in all applications, particularly those using databases, to provide prompts and labels that cause the user to enter the right type of words (i.e., data) into a particular field. However, the significant difference is that while the prompt plus label plus field visual structure is the same or similar in both cases, its purpose, and how it is used and what it achieves when used that way is completely different in the two cases:

In the case of conventional use, the purpose, intent and activity of a field/prompt/label combination is to limit, reduce and restrict the data the user enters to exactly the type of data the prompt and label say is required. For example, if a field is labeled “Departure Date” that field is then set so as to only accept information that is formatted as a date. Characteristically also, only one field can accept a specific data type. For example if there is a field labeled “First Name of Salesman” such a field will accept the word John. If there is another field labeled “Item Sold” it will not accept the word “John” but will only accept “chair” or some other word indicating an object.

In the case of Meaning Processing Level 0 screen that is using the same field/prompt/label structure any field will accept any data and the label and prompt displayed by the field are treated not as restrictions on what may be entered, but as factors that are used to subconsciously get the user to select a particular meaning of the word. For example, if there is a field on meaning processing Level 0 screen that displays the word “Action you want to do” and another which displays “type of document” both will accept the word “fax.” But in the case where the word “fax” is entered into the field displaying the prompt of “Action you want to do” the word fax is treated as having the meaning of an action, whereas, if the identical characters fax” is typed into the field displaying the Prompt or label “type of document,” then the same characters are treated and handled as if they had a completely different meaning, namely that of a type of document.

Hence, in Meaning Processing Level 0, the identical structure of field/prompt/label is used but the data entered is processed in a completely different manner by the underlying field parallel logics, also saved and acting in the form of virtual or actual DRT records.

In effect it is the particular wording that is used, and the particular processing that is applied to data entered on a screen that determines whether it a Meaning Processing Level 0 screen or a classic screen used in the normal manner. Classic screens do not perform Meaning Processing, whereas the type of screen constructions and the Any to Any Component Computing System lying behind the screen, as described here, act in partnership to perform one type of Meaning Processing.

Note that although Level 0 Meaning Processing is described in relation to a screen, the same principles apply equally to non-visual interfaces in which text to speed and speech to text interface with the user, and the prompts that ask the user questions and translated to and from speech by suitable software.

In the field-by-field visual construction of a Level 0 Meaning Processing screen one field equates directly to one underlying DRT field. However, various software logics can be interposed between the screen and the underlying Data Relation Table record, so that a user can enter data into what is shown to him as one field, for example a field labeled “Name” and into this field he can enter Mr. John Brown Junior. Interposing software logics then parse this string into the correct fields of the underlying DRT record.

The field-by-field visual construction of a Level 0 Meaning Processing screen also creates several other major advantages as follows:

Simply by re-arranging the positioning of the same field in two different. screens, different underlying DRT records can effectively receive data that is completely different in meaning. For example, in one screen a First name field can be arranged at the top of the screen in what is instinctively recognized as being the position for the first name of an addressee in a letter. That data is recorded by the underlying DRT record as the first name, of the receiver of the letter.

The very same field, with the very same look—identical in every respect—when moved by the user or the developer to a position at the bottom of the screen is instinctively recognized as being the position for the first name of the sender of the letter.

Consequently, the user will put into that field, if it is at the top of the letter-like space, the word “John” because that is the person he wants to send the letter to, if he or someone else moves that field to the bottom of the screen, he will enter the data Bill, being his name, the sender of the letter.

This mechanism enables a human meaning processing ability that is termed a spatial data relation statement, and is in effect, that the meaning of the data changes, depending on the physical position of the data. Hence, a field showing the character string “John” at the tope of a letter actually means “John, receiver,” if the same field is moved to the bottom of the space, now has a different meaning which is “John, sender.”

Because of this enabling method, the physical position on the screen of a field into which data is entered, enables the underlying Any to Any machine to detect the meaning the user is ascribing to those characters.

The field-by-field visual construction of a Level 0 Meaning Processing screen also creates a further advantage as follows:

In the classic construction of a screen that is to display—for example—a letter, the screen is simply a blank space.

In a Level 0 Meaning Processing screen a letter is constructed as many different fields. Because of this, it becomes possible to control with suitable underlying software, how those individual fields behave.

For an expert user for example, all screens may be made to appear simultaneously.

However, when this happens for a beginner, the amount of data being requested of him all at once can be overwhelming. In this case, the very same screen can, through a simple software change, be switched to operate in question and answer mode, much as a secretary might question her boss in order to obtain the necessary data as in the following example:

Prompt: What is the first name of the addressee? Enter it here

When the user has filled that in, the next field appears:

Prompt: Now, please enter the last name of the addressee here:

And so on.

A further advantage of the Level 0 Meaning Processing screen construction is that completely different looks can be created on the screen without any necessity to switch or change in any way any of the underlying DRT records or software. Shallow changes often referred to as “skins” are common in the state of the art and generally apply to an overall color scheme, but the customizing and changes that are possible with a Level 0 Meaning Processing screen are total—anything and everything can be changed, from the language of the labels and prompts to the colors and positions and shapes of every individual thing that is visible.

If, to this flexibility is added the ability to add or subtract any data relation table field and to add and subtract buttons that cause different things to happen, then now the user himself is enabled, without programmer assistance to take a simple item such as a note, and convert it into any infinity of different items—each of which does its own Level 0 Meaning processing. Adding the further ability to enable a single screen to display fields from more than one DRT record at a time then enables the user himself, without programmer assistance or intervention to create form that one simple item—a note—an infinity items such as a memo, a letter, an address record, a database, a staff application form, or other forms.

Again, with this construction, the further advantage is that every one of such items the user creates does its own Level 0 Meaning Processing detecting the correct meanings of the words the user enters.

Meaning Processing Level I

Meaning Processing Level I is a simple method of applying the principles of this invention to perform a slightly more sophisticated meaning processing, but still one that is very simple to implement, using the underlying Any to Any Component Computing System is utilized.

In this additional embodiment, a field or box exists on the screen into which the user can enter strings of words and this for sake of ease of reference is called a “talk box.” The talk box can be real—it can exist on the screen—or virtual—a software structure that mimics it can be fed by speech to text conversion operating over a telephone for example—the principles are the same.

The user enters into the talk box whatever command he wishes to give to the computer. The computer then ignores almost all words the user enters and just looks for keywords that match the words that are recorded in the actions DRT field of its installed software modules.

In effect, Level I Meaning Processing can be used separately or built on top of Level 0, and simply acts to match words the user gives with words that are related to software modules for the actions it can do and when a match is detected, the software module fires, and is visually displayed, and Level 0 Meaning Processing takes over from there on.

Simple equivalency tables enable a variety of words with different meanings to be correctly detected.

Meaning Processing Level II

Level II Meaning Processing is the most sophisticated of all and when fully enabled, has the capacity to processing any meaning in any language and produce Data Relation Table records from the results that can then be executed by suitably constructed Any to Any Component Computing System software modules.

The Any to Any Component Computing System patent Specification and drawings describe in some detail that language can successful be treated as multiply-compressed meanings, where one compression operates on top of another. Words she as “he” are regarded as highly compressed representative of all data that is known about the immediately previously mentioned make person, for example.

Decompressing Natural Language Terms

The first activity of Meaning Processing is to remove the highest level of compressions that are found to occur in the language, created by a type of operator word that is a short form substitute for a greater mass of data. Operator words are defined as words that perform an operation, and in Meaning Processing, these words are often not directly represented in the output at all, but are used to cause associated logic to perform the “operation” they require. Examples of such words are:

“He,” “they,” “it,” “them,” “those,” “these,” “that,” “which,” “she,” “him,” “or her.”

Referent Operators

While the above examples are treated by grammar as being different, they are treated by Meaning Processing as being the same type of word, referred to as “referent operators” -“referent” in that they “refer” to other data.

The first activity of Meaning Processing is to replace referent operators, if present, with the actual data they refer to and this replacement is done by the logic associated with the particular word. The action of this associated logic performs an “operation.” For example:

The operation done by the logic associated with the word “he” is to search for the nearest previous make person and substitute the NCL representing that person's name in the place of the word “he.”

The identical operation is performed lot the word “him,”

The logic associated with the words “she” and “her” acts identically to the logic associated with the words “he” and “him” with the difference that the logic searches for the nearest previous female person instead of the nearest previous male person.

Similarly, software is written to perform the various types of decompressions outlined and described in the Any to Any Component Computing System patent Specification and drawings.

The Any to Any Component Computing System Patent Specification and drawings also describe a method for determining when a series of words “make sense.” The methodology described there is used in another manner to determine which meanings of a given word are the correct ones to use, as follows:

Requirement Rules—For Determination of Which Meaning Applies When Multiple Meanings Exist.

One of the most basic actions that needs to be performed in Level II Meaning Processing is to determine which meanings of words that have several meanings for a particular spelling is present and in operation.

The method to do this is referred to as requirement rules, in which it is supposed that a particular meaning of a particular word “requires” another type of word in order to be “satisfied.”

For example, if a person says the word “I” and nothing else, after a pause the listener is likely to say “I what? What about “I”?”—I needs, or requires something in order to be “happy.” The speaker adds another word “jump.” The word “I” has had its requirements met—what it wanted was an action—a particular type of word expressing an action.

However, while “I” has had its requirement rule satisfied, the word “jump” has not had its requirement rule satisfied. It requires something. The user adds the word “the” and now both the word “jump” and the word “the” have requirements, neither of which are satisfied. If the speaker says “I jump the” and stops there, sooner or later the listener will grow irritated and ask “well! What is it you intend to jump?“As far as the listener is concerned what has been said is incomplete, something else is still required—hence the term “requirement rule.” Eventually, suppose that the speaker add the word “fence” so that his entire utterance becomes “I jump the fence.”

To the listener “I jump the fence” said by someone else makes sense and nothing else needs to be added in order to understand that utterance as itself. The user may want to know why or something like that, but that is not a mechanism that is useful in determining the particular meanings of words so far uttered.

Notice that the word “jump” has at least the following meanings:

Jump—as an action: “I jump over the tree.”

Jump—as a thing: “I leapt over the jump.”

Similarly the word “fence” has at least the following meanings:

Fence—the thing: “I jumped over the fence.”

Fence—as an action: “I fenced the stolen ring.”

Thus the word “fence” and the word “jump” both have two meanings one of which is a thing and one of which is action, yet despite that, the listener detects that the word “jump” in the utterance “I jump over the fence” is the action meaning of jump, while the word “fence” in the same utterance “I jump over the fence” is the thing meaning of the word “fence.”

Now consider if the words are reversed in the same utterance:

“I fence the jump.”

The listener construes that the meaning of the word “fence” in use in this case is the action meaning, while the meaning of “jump” that is in use on this occasion is the thing meaning of the word “jump.”

Now consider the same utterance with the word “the” removed and again reverse the word sequence.

“I fence jump”

“I jump fence”

In this example, “fence jump” could mean either “I put a fence round the jump” or “I jump over the fence” —the utterance has become ambiguous and which way of the alternative ways it gets understood depends on the listeners bent and will frequently lead to confusion or the requirement for clarification.

This illustrates the point that the word “the” itself has its own requirement rule, which is that it requires a type of word that is a word for a material thing.

This further illustrates the principle of processing requirement rules, namely, that:

It is the earliest or first solution that satisfies all requirement rules in play that selects the meanings in use.

The following table, showing different possible meanings of each of the words in the utterance “I jump the fence,” together with their requirement rules, illustrates

| Line | | | | Energy/Action | | | Character | |
|---|---|---|---|---|---|---|---|---|
| # | Life | Time | Space | Action | Ability | Matter | strings | Different meanings possible |
| 1 | i | | | | Yes | | i | “i” as representing a person |
| 2 | | | | | No | I | i | “I” as a character |
| 3 | | | | Jump | yes reqd | | jump | “Jump” as an action |
| 4 | | | | | | Jump | jump | “Jump” as a thing |
| 5 | the | | | | | | the | |
| 6 | | | | fence | yes reqd | | fence | “fence” as an action |
| 7 | | | | | | Fence | fence | “fence” as a thing |

The above table shows the data category to which a particular meaning of a word belongs and the data category or data class of the word—i.e., the type of word—that particular meaning requires, in order for that particular meaning of the word to be in force.

The column “ability” shows entries stating abilities that are required by that particular meaning of that word.

Hence line numbered 1 in the above table shows the meaning of the “i” when “i” refers to a person and the DRT record entry represented by the line numbered 1 in the table shows that:

This meaning of “i” is a meaning that is in the life data category.

For this meaning to be valid, it requires a word of the action data category.

This particular meaning has the capacity of independent action—signified by the “yes” in the energy, ability column.

Hence the line numbered 2 in the above table shows the meaning of the “i” when “i” refers to a character and the DRT record entry represented by the line numbered 2 in the table shows that:

This meaning of “i” is a meaning that is in the matter data category.

For this meaning to be valid, it requires a word of the action data category.

This particular meaning does not have the capacity of independent action—signified by the “no” in the energy ability column.

Hence the line numbered 3 in the above table shows the meaning of the “jump” as an action is represented by the DRT record entry represented by the line numbered 3 in the above table showing that:

This meaning of “jump” is a meaning that is in the action data category.

For this meaning to be valid, it requires a word with a meaning in the action data category, and in the life data category.

This particular meaning requires the capacity of independent action to be present in the meanings of one of the other words—and this is signified by the “yes reqd.”

Hence the line numbered 4 in the above table shows the meaning of the “jump” as matter (for example, something which is jumped) and this is shown by the DRT record entry represented by the line numbered 4 in the above table which shows that:

This meaning of “jump” is a meaning that is in the matter data category,

For this meaning to be valid, it requires a word with a meaning in the action data category.

Hence the line numbered 5 in the above table shows the meaning of the “the” as belonging to the Life Data Category and this is shown by the DRT record entry represented by the line numbered 5 in the above table which shows that:

This meaning of “the” is a meaning that is in the Life Data Category,

For this meaning to be valid, it requires, a word with a meaning in the matter data category.

Hence the line numbered 6 in the above table shows the meaning of the “fence” as an action is represented by the DRT record entry represented by the line numbered 6 in the above table showing that:

This meaning of “fence” is a meaning that is in the action data category.

For this meaning to be valid, it requires a word with a meaning in the action data category, and in the life data category.

This particular meaning requires the capacity of independent action to be present in the meanings of one of the other words—and this is signified by the “yes reqd” in the energy, ability column.

Hence the line numbered 4 in the above table shows the meaning of the “fence” as matter (for example, something which is fenced) and this is shown by the DRT record entry represented by the line numbered 4 in the above table which shows that:

This meaning of “fence” is a meaning that is in the matter data category.

For this meaning to be valid, it requires a word with a meaning in the action data category.

Processing Requirement Rules

It is important that processing of requirement rules occurs in the order in which the words are received. Software to process requirement rules can be written in a number of ways taking advantage of various methods available in the state of the art and the software follows the following methodology: When the first word “i” is received, the rules represented by lines 2 and 3 are brought into play.

With the receipt of the word “jump” two more rules, presented by lines 3 and 4 are brought into play. As soon as lines 3 and 4 are in operation, it can be seen that whereas line 3 satisfies the requirement of line 1, and therefore selects the line 1 meaning of the character “i” (I as a person), neither line 3 nor line 4 satisfy the line 2 requirements. Hence, at this point, lines 1 and 2 are no longer part of the picture but both lines 3 and 4 are in operation. Line 3 requires the arrival of a word belonging to the matter data category, while Line 4 requires one belonging to the action data category.

The arrival of line 5, containing the word “the” does nothing to satisfy the requirements of lines 3 and 4, and instead adds its own requirement for a matter data category word to follow.

The receipt of the word “fence” brings lines 6 and 7 in to play. Line 7 satisfies the requirement of line 5 “the” —i.e. it is the matter meaning that the requirement rule for line 5 (“the”) requires, and hence, acts to select the Line 7 (matter) meaning of “fence”.

Because the Line 7 meaning of “fence” —the word “fence” as matter—is now selected, the line 3 meaning of “jump” is satisfied (but not the line 4 meaning of “jump” as a thing).

Hence, at this point there is a solution that satisfies all the requirement rules of one or other meaning of each word and the solution is as follows:

| | |
|---|---|
| I | Line 1, “I” as a person |
| Jump | Line 3, “jump” as the action |
| The | line 5 |
| Fence | line 7 “fence” as a thing. |

As will be seen, there is no other solution available with the words received that satisfies the requirement rules of at least one meaning of each word.

Making Sense

Relating the above to the description in the Specification and drawings of the Any to Any Component Computing System application, software is written such that when a series of words is received whose requirement rules act so as to satisfy one another, and this occurs later in the sequence of the words received than for a series of words whose requirement rules are not satisfied, then the earlier received words (those whose requirement rules do not satisfy one another) are categorized as “not making sense” and are queried with the user in order to either obtain additional meanings from the user, or, so as to result in the users input being corrected.

Software Construction

The basic principles of Meaning Processing are the decompression and requirements rules, and the principles and understanding extensively described in the associated Any to Any Component Computing System Specification and drawings. Once these principles are understood it will be apparent to those skilled in the art, an infinity of ways exists to write the software to perform Meaning Processing.

While this method has useful functionality, this coding method presents problems as its extensibility is limited and the addition of each new operator word results in extensive revisions being required to the pre-existing code. The reason for this is that the interplay of the different meanings is of sufficient complexity, that unless the component principle as described in the Any to Any Component Computing System Specification and drawings, and each meaning of each word is record separately—enabling it to be processed by matching separate software—then the complexity that evolves becomes self limiting, so that the entirety of the language cannot in fact be programmed and processed except perhaps, with extreme difficulty.

Therefore the preferred method is:

That each meaning of each word, along with its spelling and NCL translation is recorded in a single DRT NCL record, and this record also contains:

Its requirement rules or reference to them.

Its conditions, i.e., the conditions under which that meaning is operative, or reference to them.

Its logics, i.e., the logics that perform the operations that meaning requires, or reference to them.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

The invention claimed is:

1. A method for computer-based natural language word meaning processing for use with a computer-based system for processing natural language word commands to produce actions or other results that would generally be produced by a human interpreting the particular natural language word command, comprising the following steps:
designating a distinguishable symbol corresponding to each individual meaning of individual natural language words and to each individual meaning of each component of said natural language words,
further categorizing said distinguishable symbols into programmable category fields that include the applicable requirement rules, conditions and logics needed for said computer-based system for processing natural language word commands to produce actions or other results to interface with said database to translate word commands and process the meanings of such words correctly, and
storing said categorized distinguishable symbols in a data relation record database that interfaces and is compatible with said system for processing commands to produce actions or other results,
such that when a natural language word is inputted into a computer that utilizes said process and command processing system, said natural language words are translated into said distinguishable symbols and said system for processing commands to produce desired actions or other results understands said translation and executes said translated command to produce the result that a human would generally intend and interpret has been requested by said command.

2. The method of claim 1, wherein said distinguishable symbols are numeric.

3. The method of claim 1, wherein said step of further categorizing said distinguishable symbols comprises applying requirement rules for identifying the desired meaning of a particular word when multiple meanings exist for said word, based on selection and placement of accompanying words.

4. The method of claim 1, wherein said step of further categorizing said distinguishable symbols comprises applying logic that replaces referent operators with the data referred to by said referent operators.

5. A system for computer-based natural language word meaning processing for use with a computer-based system for processing natural language word commands to produce actions or other results that would generally be produced by a human interpreting the particular natural language word command, comprising:
means for assigning a distinguishable symbol corresponding to each individual meaning of individual natural language words and to each individual meaning of each component of said natural language words,
means for further categorizing said distinguishable symbols into programmable category fields that include the applicable requirement rules, conditions and logics needed for said computer-based system for processing natural language word commands to interface with said database to translate word commands and process the meanings of such words correctly, and
means for storing said categorized distinguishable symbols in a data relation record database that interfaces and is compatible with said system for processing commands to produce actions or other results,
such that when a natural language word is inputted into a computer that utilizes said process and command processing system, said natural language words are translated into said distinguishable symbols and said system for processing commands to produce desired actions or other results understands said translation and executes said translated command to produce the result that a human would generally intend and interpret has been requested by said command.
